(19) United States
(12) Patent Application Publication
(10) Pub. No.: US 2006/0133453 A1
(43) Pub. Date: Jun. 22, 2006

(54) Data transfer system

(76) Inventor: Nobuaki Yokoyama, Tokyo (JP)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/202,302

(22) Filed: Aug. 11, 2005

(30) Foreign Application Priority Data
Dec. 21, 2004 (JP) 2004-369258

(51) Int. Cl. H04B 1/69

(52) U.S. Cl. 375/130

(57) ABSTRACT

The present invention provides a data transfer system that performs a data transfer between a master receiver and at least one slave receiver each of which has a built-in memory storing data therein and is identical in configuration. Upon the data transfer, such at least one slave receiver in which the data transfer is performed, is disposed in the neighborhood of the master receiver. The master receiver FSK-modulates a local oscillation signal of a first local oscillator and a standard frequency signal of a standard signal generator using the data read from the corresponding built-in memory, and radiates the first local oscillation signal generated from the first local oscillator into the air as a leakage radio wave, whereas such at least one slave receiver receives the leakage radio wave therein and writes data acquired from the received signal into the corresponding built-in memory, whereby a data transfer is performed between the master receiver and the slave receiver.

### RELATED/PRIORITY APPLICATION

This application claims priority with respect to Japanese Application No. 2004-369258, which was filed Dec. 21, 2004, and is incorporated herein by reference in its entirety.

### BACKGROUND OF THE INVENTION

1. Field of the Invention

The present invention relates to a data transfer system, and particularly to a data transfer system that makes it possible to transfer data stored in a built-in memory of a master receiver to a built-in memory of at least one slave receiver all at once using a leakage radio wave propagated into the air from the master receiver.

2. Description of the Related Art

An auto race is of such a fierce race that a large number of competition vehicles or cars run along a specific course in a race car site or motordrome over tens of laps and car racing is carried out for hours together in that case. Accidents, driver's alternation, tire changes, refueling, troubleshooting, etc. take place on the way to the racing. Alternation in ranking among the competition cars and changes in the states of traveling of the competition cars occur as occasion arises. Thus, spectators that will watch the auto race cannot take their eyes off the auto race. Therefore, the audience needs to intercept calls based on radio signals communicated between the competition cars and the pits and always grasp driving conditions of the competition cars.

Consequentially, an auto race organizer makes known to these spectators in advance, various data related to the respective competition cars, i.e., car numbers set to the competition cars, usable frequencies of radio signals, channel numbers for the radio signals, driver names, type of competition cars and other data. Therefore, some of the spectators carry their own cellular phone type radio-signal intercept receivers upon race-watching and set reception frequencies of the radio signal intercept receivers in accordance with the data made known to the public by the organizer to intercept calls based on a desired radio signal, or indicate necessary data on their displays to always grasp the states of the competition cars. These radio-signal intercept receivers act as devices indispensable upon race-watching.

Meanwhile, the respective spectators purchase their own radio-signal intercept receivers and write necessary data in the purchased radio-signal intercept receivers as needed each time auto racing is opened. This is too specialized or technical to use the receivers as real means. That is, this is because since these data differ each time auto racing is opened and also differ every auto racing sites, there is a need to write the corresponding data each time the auto racing is opened.

With such a situation in view, receiver rental agents that lend radio-signal intercept receivers with necessary data written therein to spectators that desire them have appeared upon the opening of an auto race. In this case, prior to the opening of the auto race, the receiver rental agents need to prepare, in advance, a large number of radio-signal intercept receivers in which data fit for the auto race have been written.

The writing of data into each radio-signal intercept receiver is normally carried out by the following two methods. The first method is a method for connecting, using a cable, information processing equipment such as a personal computer in which necessary data are stored in a memory, and a radio-signal intercept receiver in which data are written, allowing the necessary data to be transferred from the information processing equipment to the radio-signal intercept receiver through the cable, and writing the data into a memory of the radio-signal intercept receiver. The second method is a method for preparing a master receiver (may also be information processing equipment such as a personal computer or the like) wherein necessary data are stored in a memory, connecting the master receiver and a wireless transmission system by using a cable, allowing the necessary data to be transmitted from the master receiver to the wireless transmission system through the cable, when at least one radio-signal intercept receiver (hereinafter called “slave receiver”) has received a radio signal transmitted from the wireless transmission system, allowing the slave receiver to demodulate data contained in its received signal, and writing the demodulated data into a built-in memory thereof.

In this case, the first method is used as one for, when data are respectively written into the memories of many slave receivers, cable-connecting every slave receiver to the master receiver and thereafter transferring the data stored in the built-in memory of the master receiver to the corresponding memory of each slave receiver through the cable. Therefore, enormous amounts of data transfer time are needed to write the data into the memories of many slave receivers. This cannot be said to be a means sharply realistic as a data transfer means. On the other hand, the second method is equivalent to one wherein since the data are sent to at least one slave receiver using the radio signal, data transfer time remains unchanged even though the number of slave receivers intended for data transfer increases. Thus, the second method is exclusively used in this type of data transfer system.

This type of data transfer system using the radio signal normally makes use of an audio frequency FSK (Frequency Shift Keying) signal which is data having a communication or transmission rate of 1200 bps and whose Mark frequency is 1200 Hz and Space frequency is 1800 Hz. This FSK signal is equivalent to one in which when it is transmitted from the wireless transmission system as a radio signal, a high-frequency carrier wave signal is amplitude-modulated (AM) or frequency-modulated (FM). When the slave receiver receives the amplitude-modulated or frequency-modulated high-frequency carrier wave signal therein, it demodulates the FSK signal from the received signal to reproduce data and writes the reproduced data into its built-in memory. Thus, since the data retained in the built-in memory of the master receiver is transferred to the corresponding slave receiver and the same data as the master receiver is reproduced in its built-in memory, such a data transfer system is called “OAC (On Air Clone”).

According to the already-known second method in this case, when the radio signal modulated based on the audio frequency FSK signal constituting the data is transmitted from the wireless transmission system to one or more slave receivers and the one or more slave receivers respectively receive the radio signal therein, the data extracted from the received signals are stored in their corresponding built-in memories. It is therefore possible to write the data into the built-in memories of the one or more slave receivers at a time.

While on the contrary, this type of wireless transmission system forms the audio frequency FSK signal using the data supplied from the master receiver through the transmission cable and re-modulates the high-frequency carrier wave signal at the formed audio frequency FSK signal to obtain the corresponding radio signal. Thus, the wireless transmission system needs a dedicated FSK modulator having a special function, which is called an audio frequency FSK modulator. With its need, the manufacturing cost of this type of wireless transmission system becomes expensive.

### SUMMARY OF THE INVENTION

The present invention has been made in view of such a background art. An object of the present invention is to provide a data transfer system capable of directly transferring data from a master receiver to at least one slave receiver through a radio signal without using a wireless transmission system dedicated to data writing, and performing the transfer of data from the master receiver to the slave receiver simply and at low cost.

In order to attain the above object, there is provided a data transfer system which comprises a master receiver and at least one slave receiver respectively having built-in memories storing data therein and being identical in configuration to each other, and includes first means wherein after such at least one slave receiver in which a data transfer is performed, is disposed in the neighborhood of the master receiver, the master receiver reads the data stored in the built-in memory upon the data transfer, FSK-modulates an oscillation signal of a local oscillator and a standard frequency signal of a standard signal generator using the read data respectively, and radiates the oscillation signal generated from the local oscillator at that time into the air as a leakage radio wave, and wherein when such at least one slave receiver receives the leakage radio wave radiated into the air, the slave receiver extracts data contained in the received signal and writes the extracted data into the corresponding built-in memory, whereby a data transfer is performed between the master receiver and the slave receiver.

In the first means, the local oscillator may preferably be a first local oscillator employed in a PLL of a first frequency conversion stage that frequency-converts a receive high frequency signal to a first intermediate frequency signal.

Also in order to attain the above object, there is provided a data transfer system which comprises a master receiver and at least one slave receiver respectively having built-in memories storing data therein and being identical in configuration to each other, and which includes second means wherein after such at least one slave receiver in which a data transfer is performed, is disposed in the neighborhood of the master receiver, the master receiver reads the data stored in the built-in memory upon the data transfer, FSK-modulates an oscillation signal of a local oscillator using the read data, and radiates the oscillation signal generated from the local oscillator at that time into the air as a leakage radio wave, and wherein when such at least one slave receiver receives the leakage radio wave radiated into the air, the slave receiver extracts data contained in the received signal and writes the extracted data into the corresponding built-in memory, whereby a data transfer is performed between the master receiver and the slave receiver.

In the second means, the local oscillator may preferably be a second local oscillator which is connected to a stage subsequent to a first frequency conversion stage and used in a second frequency conversion stage that frequency-converts a first intermediate frequency signal obtained at the first frequency conversion stage to a second intermediate frequency signal, or may preferably be a third local oscillator which is connected to a stage subsequent to the first frequency conversion stage and the second frequency conversion stage and which is used in a third frequency conversion stage that frequency-converts a second intermediate frequency signal obtained at the second frequency conversion stage to a third intermediate frequency signal.

According to the first means, when the data transfer is reached, the master receiver reads the data stored in the built-in memory after at least one slave receiver in which the data transfer is performed, is disposed in the neighborhood of the master receiver, FSK-modulates the oscillation signal of the local oscillator and the standard frequency signal of the standard signal generator using the read data respectively to thereby generate the local oscillation signal, and radiates the local oscillation signal generated at that time into the air as the leakage radio wave. Further, such at least one slave receiver placed in the neighborhood of the master receiver receives the leakage radio wave radiated into the air, demodulates the data contained in the received signal and writes it into the corresponding built-in memory. Therefore, an advantageous effect is brought about in that there is no need to use a wireless transmission system or apparatus with a dedicated FSK modulator having a special function that acts as intermediary for data transfer, and the data retained in the built-in memory of the master receiver can directly be transferred to such at least one slave receiver through the leakage radio wave all at once.

When a PLL is of a synthesizer configuration in this case, a voltage-controlled oscillator (VCO) used as the local oscillator contained in the PLL has the function of being operated as an FM modulator. Therefore, if the voltage-controlled oscillator is supplied with data, then an FSK signal can be obtained with extreme ease. When, however, the oscillation signal of the voltage-controlled oscillator is FSK-modulated according to data, then a normal NRZ (Non Return to Zero)-type oscillation signal cannot be transmitted.

That is, the NRZ-type oscillation signal contains a DC component therein and its DC value varies depending upon the contents of data. This is because when the voltage-controlled oscillator of the PLL having the synthesizer configuration is supplied with the data, the center frequency of the local oscillation signal varies depending on the DC value. In order to avoid such a variation in the center frequency thereof, a scramble system substantially constant or zero in DC component, or a Manchester code or the like may be used. When, however, data to be transferred is not so increased, the data can be transmitted in a state of avoiding the variation in the center frequency of the local oscillation signal if the voltage-controlled oscillator is subjected to FSK modulation based on the data and at the same time the standard frequency signal generated from the standard signal generator, which is supplied to the PLL, is also added with FSK modulation, even though such a scramble system or Manchester code or the like is not used. The first means adopts the means that simultaneously effects FSK modulation on the first local oscillator and the standard signal generator.

On the other hand, when the scramble system or the Manchester code is used, both the master receiver on the transmitting side and the slave receiver on the receiving side need to perform code processing. Since such processing is performed under digital processing, it can be carried out within a microprocessor unit (MPU). However, there are also the demerits that when the scramble system is used, the time required to set a scramble prior to data transmission is slightly needed, whereas when the Manchester code is used, a data transfer rate is reduced by half upon decoding. Adopting a means for simultaneously effecting FSK modulation on the first local oscillator and the standard signal generator enables avoidance of these demerits. Incidentally, the adoption of the means for simultaneously performing the FSK modulation on the first local oscillator and the standard signal generator brings about the large merit in that although compatibility with the already-known master receiver is not maintained, there is no need to use the wireless transmission apparatus with the dedicated FSK modulator having the special function.

According to the second means, when the data transfer is reached, the master receiver reads the data stored in the built-in memory after at least one slave receiver in which the data transfer is performed, is disposed in the neighborhood of the master receiver, FSK-modulates the oscillation signal of the local oscillator using the read data to thereby generate the local oscillation signal, and radiates the local oscillation signal generated at that time into the air as the leakage radio wave. Further, such at least one slave receiver placed in the neighborhood of the master receiver receives the leakage radio wave radiated into the air, demodulates the data contained in the received signal and writes it into the corresponding built-in memory. Therefore, an advantageous effect is brought about in that there is no need to use the wireless transmission apparatus with the dedicated FSK modulator having the special function that acts as intermediary for the data transfer, and the data retained in the built-in memory of the master receiver can directly be transferred to such at least one slave receiver through the leakage radio wave all at once by only the use of a simple constitutional means.

According to the second means in this case, when the local oscillator is of a single configuration and is not contained in the PLL having the synthesizer configuration, that is, when the local oscillator is of the second local oscillator employed in the second frequency conversion stage or the third local oscillator employed in the third frequency conversion stage, the standard frequency signal of the standard signal generator is not FSK-modulated. Therefore, the second means can obtain the advantage that the data retained in the built-in memory of the master receiver can directly be transferred to at least one slave receiver through the leakage radio wave all at once by the use of a simple constitutional means.

Other features and advantages of the present invention will become apparent upon a reading of the attached specification.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a block diagram showing a configuration of an essential part of a master receiver employed in a first embodiment;

FIG. 2 is a block diagram illustrating a configuration of an essential part of a slave receiver employed in the first embodiment; and

FIG. 3 is a block diagram showing a configuration of an essential part of a master receiver employed in a second embodiment.

### DETAILED DESCRIPTION OF THE PREFERRED EMBODIMENTS

Preferred embodiments of the present invention will be explained hereinafter with reference to the accompanying drawings.

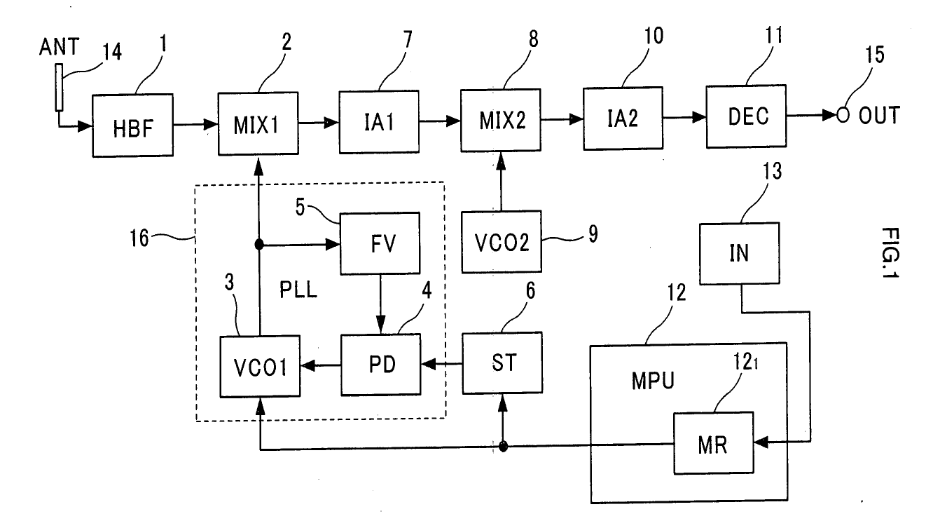

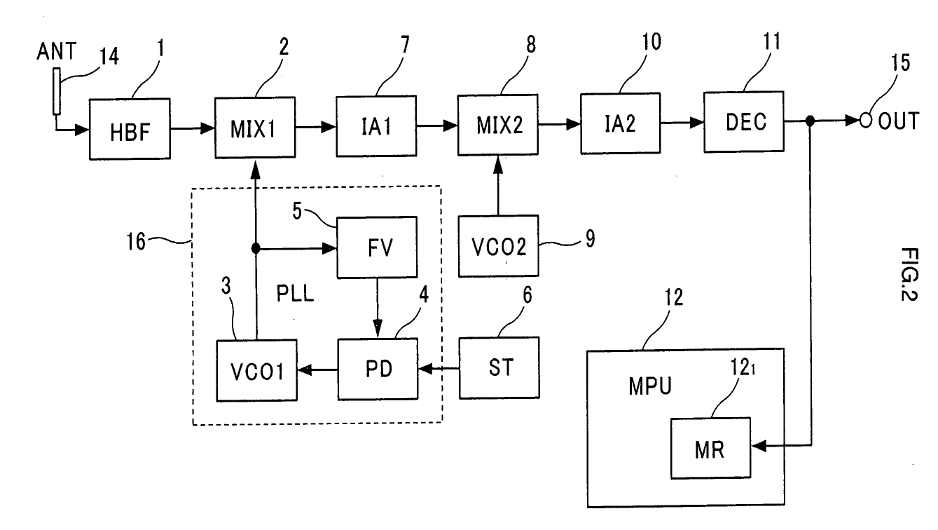

FIGS. 1 and 2 relate to a first embodiment illustrative of a data transfer system according to the present invention, wherein FIG. 1 is a block diagram showing a configuration of an essential part of a master receiver employed in the first embodiment, and FIG. 2 is a block diagram illustrating a configuration of an essential part of a slave receiver employed in the first embodiment, respectively.

As shown in FIG. 1, the master receiver includes a high-frequency bandpass filter (HBF) 1, a first frequency mixer (MIX1) 2, a first voltage-controlled oscillator (VCO1) 3, a phase comparator or detector (PD) 4, a frequency divider (FV) 5, a standard signal generator (ST) 6, a first intermediate frequency amplifier (IA1) 7, a second frequency mixer (MIX2) 8, a second voltage-controlled oscillator (VCO2) 9, a second intermediate frequency amplifier (IA2) 10, a frequency discriminator (DEC) 11, a microprocessor unit (MPU) 12 having a built-in memory (MR) 12₁, an operation input section (IN) 13, an antenna (ANT) 14, and a signal output terminal (OUT) 15. In this case, the first voltage-controlled oscillator 3, the phase detector 4 and the frequency divider 5 form a PLL (Phase-Locked Loop) 16.

And the high-frequency bandpass filter 1 has an input terminal connected to the antenna 4 and an output terminal connected to a first input terminal of the first frequency mixer 2. The first frequency mixer 2 has a first input terminal connected to an output terminal of the first voltage-controlled oscillator 3, and an output terminal connected to an input terminal of the first intermediate frequency amplifier 7. The first voltage-controlled oscillator 3 has a first control terminal connected to an output terminal of the phase detector 4, a second control terminal connected to the microprocessor unit 12, and the output terminal connected to an input terminal of the frequency divider 5. The phase comparator 4 has a first input terminal connected to an output terminal of the frequency divider 5, and a first input terminal connected to the standard signal generator 6. The standard signal generator 6 has a control terminal connected to the microprocessor unit 12.

The second frequency mixer 8 has a first input terminal connected to an output terminal of the first intermediate frequency amplifier 7, a second input terminal connected to an output terminal of the second voltage-controlled oscillator 9, and an output terminal connected to an input terminal of the second intermediate frequency amplifier 10. The intermediate frequency amplifier 10 has an output terminal connected to an input terminal of the frequency discriminator 11. The frequency discriminator 11 has an output terminal connected to the signal output terminal 15. The microprocessor unit 12 is connected to the operation input section 13.

On the other hand, as shown in FIG. 2, the slave receiver has the same configuration as the master receiver, apart from its part. If the same constituent elements or components as those of the master receiver are given the same reference numerals, then the slave receiver is provided with a high-frequency bandpass filter (HBF) 1, a first frequency mixer (MIX1) 2, a first voltage-controlled oscillator (VCO1) 3, a phase comparator or detector (PD) 4, a frequency divider (FV) 5, a standard signal generator (ST) 6, a first intermediate frequency amplifier (IA1) 7, a second frequency mixer (MIX2) 8, a second voltage-controlled oscillator (VCO2) 9, a second intermediate frequency amplifier (IA2) 10, a frequency discriminator (DEC) 11, a microprocessor unit (MPU) 12 having a built-in memory (MR) 12₁, an antenna (ANT) 14, and a signal output terminal (OUT) 15 but is not provided with an input operation section 13 alone. Even in this case, the first voltage-controlled oscillator 3, the phase detector 4 and the frequency divider 5 form a PLL (Phase-Locked Loop) 16.

Connected states of the respective components employed in the slave receiver are different from those of the master receiver in the following points. That is, there are merely differences therebetween in that the second control terminal of the first voltage-controlled oscillator 3 in the master receiver, the control terminal of the standard signal generator 6 and the microprocessor unit 12 are respectively connected to one another, whereas such connections are not carried out in the slave receiver and in that the input operation section 13 is connected to the microprocessor unit 12 in the master receiver, whereas the output terminal of the frequency discriminator (DEC) 11 is connected to the microprocessor unit 12. There are no differences therebetween in points other than the above. Therefore, the connected states of the components employed in the slave receiver will not further be explained.

The operations of the master receiver and slave receiver employed in the first embodiment will now be explained using FIGS. 1 and 2.

Prior to the transfer of data from the master receiver to the slave receiver, the master receiver first needs to store various data employed in an auto race to be opened next, such as car numbers, usable frequencies, channel numbers, driver names, the type of vehicles or cars and other data in the built-in memory 12₁ of the microprocessor unit 12. The operation of storing the various data in the master receiver is done as follows: When the input operation section 13 is operated to input the corresponding data after the microprocessor unit 12 of the master receiver has been set to a data write mode, the input data are stored in the built-in memory 12₁.

Next, when the transfer of the data from the maser receiver to the slave receiver is done, at least one slave receiver to which the data transfer is made, is placed in the neighborhood of the master receiver, and the master receiver and such at least one slave receiver are respectively brought to an operating state. When the microprocessor unit 12 of the master receiver is set to a data transfer mode upon such a state, data to be transferred from the built-in memory 12₁ of the master receiver are sequentially read, and the read data are supplied to the standard signal generator 6. A standard frequency signal outputted from the standard signal generator 6 is FSK-modulated according to the data. Simultaneously with it, the read data are supplied even to the first voltage-controlled oscillator 3. Thus, a first local oscillation signal outputted from the first voltage-controlled oscillator 3 is FSK-modulated according to the data. That is, since the standard frequency signal for setting the oscillation frequency of the first local oscillation signal is FSK-modulated according to the data, and the first local oscillation signal is FSK-modulated according to the data even in the first voltage-controlled oscillator 3, such a first local oscillation signal that a variation in center frequency can be avoided can be generated.

The first local oscillation signal generated from the first voltage-controlled oscillator 3 is radiated into the air as a leakage radio wave through a signal transmission path extending from the first voltage-controlled oscillator 3 to the first frequency mixer 2, a signal transmission path extending from the first frequency mixer 2 to the high-frequency bandpass filter 1 or the antenna 4. At this time, such at least one slave receiver disposed in the vicinity of the master receiver receives the leakage radio wave at its antenna 14 and thereby obtains a received signal through the high-frequency bandpass filter 1. Incidentally, the settings of the frequency of the first local oscillation signal and the reception frequency of such at least one slave receiver will be described later. Such at least one slave receiver frequency-converts the obtained received signal to a first intermediate frequency signal at the first frequency mixer 2 and amplifies the first intermediate frequency signal at the first intermediate frequency amplifier 7. Next, the slave receiver frequency-converts the first intermediate frequency signal to a second intermediate frequency signal at the second frequency mixer 8, amplifies the second intermediate signal at the second intermediate frequency amplifier 10 and thereafter demodulates it at the frequency discriminator 11 to extract baseband data. And the extracted data are sequentially written from the frequency discriminator 11 to the built-in memory 12₁ through the microprocessor unit 12.

Thus, upon the data transfer, the data stored in the built-in memory 12₁ are radiated into the air as the leakage radio wave, and such at least one slave receiver having received the data therein extracts the data from the leakage radio wave and writes the same into the built-in memory 12₁ thereof. It is therefore possible to perform the transfer of the data from the master receiver to at least one slave receiver all at once by merely using an extreme simple means without interposing a wireless transmission system therebetween.

A description will next be made of the setting of frequencies fit for transfer when the transfer of the data from the master receiver to the slave receiver is carried out.

Each of the master receiver and the slave receiver first sets a standard frequency signal used in a PLL synthesizer to the same frequency f_{STD} and assumes a reception frequency at the slave receiver, the frequency of a first intermediate frequency signal and the frequency of a first local oscillation signal to be f_{REC}, f_{1IF} and f_{1L0} respectively. Consequently, a relationship of f_{REC}−f_{1IF}=f_{1L0} is established. Meanwhile, the frequency of the first local oscillation signal f_{1L0} is n (where n: positive integer) times the frequency f_{STD} of the standard frequency signal employed in the PLL synthesizer, i.e., f_{1L0}=nf_{STD}. When the master receiver sets the frequency of the first local oscillation signal generated from the first local oscillator 3 to mf_{STD} (where m: positive integer), the slave receiver receives it therein. Therefore, a relationship of mf_{STD}−nf_{STD}=f_{1IF} is established. Since (m−n)=f_{1IF}/f_{STD} is obtained if this equation is rewritten, then the slave receiver is capable of receiving a received signal at a center frequency if the two integers m and n are chosen in such a manner that f_{1IF}/f_{STD} reaches an integer.

Specific numerical values of frequencies usable in the above equation will be explained by way of example in this case. Assuming that the frequency f_{1IF} of the first intermediate frequency signal=2.7 MHz and the frequency f_{STD} of the standard frequency signal=15 kHz, f_{1lF}/f_{STD}=(m−n)=180 is reached. Since n=820 is reached if m=1000, the master receiver generates 15 kHz×1000=15 MHz as the frequency of the first local oscillation signal. If 15 kHz×820=12.3 MHz is used as the frequency of the first local oscillation signal, then the slave receiver obtains 15 MHz−12.3 MHz=2.7 MHz as the frequency of the first intermediate frequency signal.

A description will be made of the reason why there is no need to especially provide a new circuit means on the master receiver side as a means for radiating the first local oscillation signal generated by the first voltage-controlled oscillator 3 of the master receiver into the air as the leakage radio wave.

Generally, in this type of radio signal intercept receiver, its reception sensitivity is approximately 0.5 μV at lowest when its input impedance is 50Ω. When the reception sensitivity is expressed in power, it is given as (0.5×10⁻⁶)²/50Ω=−117 dBm.

On the other hand, the Radio Law or Regulation provides that the intensity of a radio wave collaterally radiated into the air, which is allowed for a receiver, is 4 nW or less, i.e., −54 dBm or less if it is measured using a dummy antenna circuit equal to a receiving antenna in electrical constant (i.e., it is equivalent to the amount of power applied to the receiving antenna from the receiver).

Assuming that the oscillation output of the first local oscillation signal outputted from the first voltage-controlled oscillator 3 of the master receiver is, for example, 0 dBm as this value, the first local oscillation signal must be transmitted from the first voltage-controlled oscillator 3 to an antenna 14 terminal through the transmission paths extending from the first voltage-controlled oscillator 3 to the first frequency mixer 2 and the high-frequency bandpass filter 1 where the first local oscillation signal is radiated from the antenna 14. Since, however, the transmission paths are opposite to the direction to transmit a normal signal for the most part, the first local oscillation signal is considered to reach the antenna 14 terminal in a state in which it has been considerably attenuated in the transmission paths. Since, however, there is much difference in the degree of its attenuation depending upon the type of receiver, electric characteristics thereof and its structural state, the degree of its attenuation cannot be decided categorically.

Since, however, the first voltage-controlled oscillator 3, the first frequency converter 2, the high-frequency bandpass filter 1, and the antenna 14 terminal are considered to be laid out at distances relatively near the master receiver structurally when they are arranged, a low value like −117 dBm is not reached as the reception sensitivity.

Also the Radio Law or Regulation provides that in reference to the intensity of a radio wave of a radio station recognized to be a weak radio station, an electric field intensity in a place three meters apart from the radio station is not greater than 35 μV/m when the frequency thereof ranges from 322 MHz to 10 GHz. When the effective length of the receiving antenna is 10 cm, for example, assuming that a radio wave having an electric field intensity corresponding to a maximum limit of 35 μV/m is being emitted from the radio station, the electric field intensity reaches 3.5 μV, i.e., −96 dBm. Therefore, a margin of even 21 dB is allowed as viewed from −117 dBm. Even in a place ten meters far away from the radio station, a margin of 11 dB is still allowed. Thus, the present data transfer system is capable of performing a data transfer realistically.

### Second Preferred Embodiment

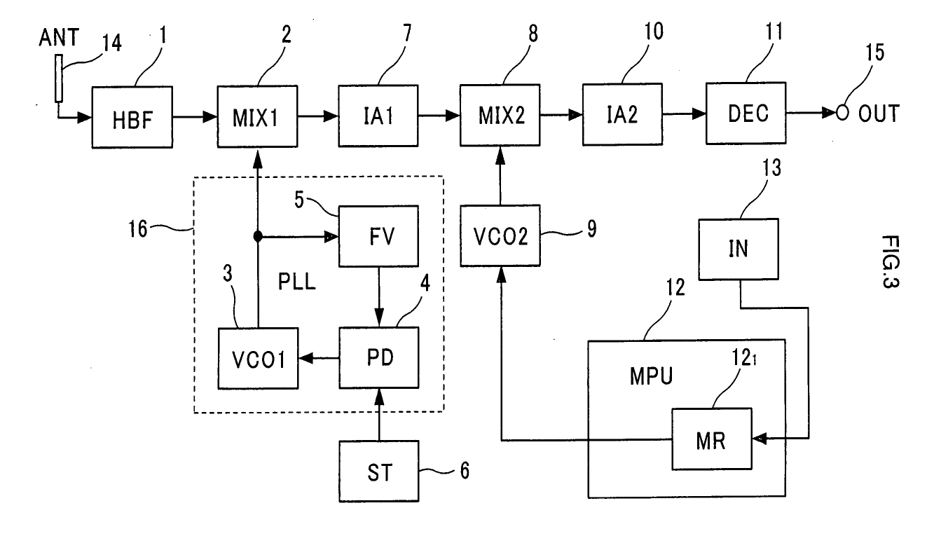

Next, FIG. 3 relates to a second embodiment of a data transfer system according to the present invention and is block diagram showing a configuration of an essential part of a master receiver employed in the second embodiment. The figure shows an example in which a second local oscillation signal outputted from a second voltage-controlled oscillator 9 is FSK-modulated according to data and the so-processed second local oscillation signal is radiated into the air as a leakage radio wave. Incidentally, the same one as the slave receiver employed in the first embodiment shown in FIG. 2 is used as a slave receiver employed in the second embodiment.

As shown in FIG. 3, the master receiver employed in the second embodiment is identical to that employed in the first embodiment shown in FIG. 1 in configuration and operation except for the following points. That is, the master receiver employed in the second embodiment is merely different from that employed in the first embodiment in that in the former master receiver, a built-in memory 12₁ lying in a microprocessor unit 12 is connected to the second voltage-controlled oscillator 9 and the oscillation signal of the second voltage-controlled oscillator 9 is FSK-modulated according to data read from the built-in memory 12₁, whereas in the latter master receiver, the built-in memory 12₁ of the microprocessor unit 12 is connected to the first voltage-controlled oscillator 3 and the standard signal generator 6, the standard frequency signal outputted from the standard signal generator 6 is FSK-modulated in accordance with the data read from the built-in memory 12₁ and at the same time the first local oscillation signal outputted from the first voltage-controlled oscillator 3 is FSK-modulated. There is no difference between the master receiver employed in the second embodiment and the already described master receiver employed in the first embodiment in configuration and operation other than the above. Therefore, the configuration and operation of the master receiver employed in the second embodiment will not further be explained.

Such frequency settings as to be described next are suitable for the master receiver and slave receiver according to the second embodiment. That is, assuming that the frequency of the second local oscillation signal generated from the second voltage-controlled oscillator 9 in the master receiver is f_{2L0}, a leakage radio wave having this frequency f_{2L0} is radiated into the air from the master receiver, whereas assuming that the frequency of a first intermediate frequency signal is f_{1IF} and the frequency of a second intermediate frequency signal is f_{2IF} in order to make it easy to cause the slave receiver to receive the frequency f_{2L0}, the frequency f_{2L0} is set to a high frequency having a relationship of f_{2L0}−f_{1IF}=f_{2IF}. Since the slave receiver receives the leakage radio wave of the frequency f_{2L0} and frequency-converts the received signal to the frequency f_{1IF} of the first intermediate frequency signal, using the frequency f_{1L0} of the first local oscillation signal, a relationship of f_{2L0}=f_{1L0}+f_{1IF} is established. Since f_{2L0}−f_{1IF}=f_{1L0} is reached if this relational expression is converted, the frequency f_{2IF} of the second intermediate frequency signal may be selected so as to reach f_{1L0}=f_{2IF} from the present expression and the aforementioned relation.

Specific numerical values of frequencies usable in the above equation will be explained by way of example in this case. Assuming that the frequency f_{1IF} of the first intermediate frequency signal=2.7 MHz and the frequency f_{2IF} of the second intermediate frequency signal=500 kHz, the frequency of the second local oscillation signal becomes f_{2L0}=3.2 MHz. Therefore, the slave receiver results in the reception of a leakage radio wave having this frequency 3.2 MHz. And the frequency f_{1L0} of the first local oscillation signal reaches 500 kHz from the aforementioned relation, i.e., the relationship of f_{1L0}=f_{2IF}. A first frequency converter 2 performs a frequency conversion of 3.2 MHz−500 kHz=2.7 MHz to obtain a first intermediate frequency signal having the frequency 2.7 MHz.

Even in the second embodiment, when the leakage radio wave is received, the slave receiver extracts data contained in its received signal at a frequency discriminator 11 and writes the extracted data from the frequency discriminator 11 to the corresponding built-in memory 12₁ through the microprocessor unit 12, whereby the transfer of the data from the master receiver to the slave receiver is performed.

Although the first embodiment has explained the example in which when the master receiver is provided with the first frequency conversion stage and the second frequency conversion stage, the oscillation signal of the first voltage-controlled oscillator 3 is FSK-modulated using the data, whereas the second embodiment has explained the example in which when the master receiver is provided with them, the oscillation signal of the second voltage-controlled oscillator 9 is FSK-modulated using the data, the master receiver may be configured in such a manner that when it is provided with a third frequency conversion stage following the first frequency conversion stage and the second frequency conversion stage in addition to them, the master receiver FSK-modulates an oscillation signal of a third voltage-controlled oscillator provided in the third frequency conversion stage. Although such a circuit configuration that the oscillation signal of the third voltage-controlled oscillator is FSK-modulated, is not shown in the figure in this case, its circuit configuration and operation are based on the example in which the oscillation signal of the second voltage-controlled oscillator 9 is FSK-modulated according to the data in the second embodiment, and can easily be inferred from the second embodiment.

Although each of the embodiments described up to now has explained the example in which upon writing necessary data into the corresponding built-in memory 12₁ of one master receiver, the operation input section 13 is operated to perform its writing, the present invention is not necessarily limited to the example in which the writing is done using the operation input section 13, as a means for writing the data into the built-in memory 12₁ of one master receiver. When information processing equipment such as a memory personal computer, or a wireless transmission system is already provided, data may be written into the built-in memory 12₁ of one master receiver by the above already-known first or second method through the use of the information processing equipment or wireless transmission apparatus. In this case, ones perfectly identical in structure to one another are used as one master receiver and at least one slave receiver. One slave receiver in which data are first written into the corresponding built-in memory 12₁, subsequently functions as a master receiver.

While the preferred forms of the present invention have been described, it is to be understood that modifications will be apparent to those skilled in the art without departing from the spirit of the invention. The scope of the invention is to be determined solely by the following claims.

What is claimed is:

1. A data transfer system comprising:
a master receiver;
at least one slave receiver,
said master receiver and said at least one slave receiver respectively having built-in memories storing data therein and being identical in configuration to each other,
wherein after said at least one slave receiver in which a data transfer is performed, is disposed in the neighborhood of said master receiver, said master receiver reads the data stored in the built-in memory upon the data transfer, FSK-modulates an oscillation signal of a local oscillator and a standard frequency signal of a standard signal generator using the read data respectively, and radiates the oscillation signal generated from the local oscillator at that time into the air as a leakage radio wave; and
wherein when said at least one slave receiver receives the leakage radio wave radiated into the air, said slave receiver extracts data contained in the received signal and writes the extracted data into the corresponding built-in memory,
whereby a data transfer is performed between said master receiver and said slave receiver.

2. The data transfer system according to claim 1, wherein the local oscillator is a first local oscillator employed in a PLL of a first frequency conversion stage that frequency-converts a receive high frequency signal to a first intermediate frequency signal.

3. A data transfer system comprising:
a master receiver;
at least one slave receiver,
said master receiver and said at least one slave receiver respectively having built-in memories storing data therein and being identical in configuration to each other,
wherein after said at least one slave receiver in which a data transfer is performed, is disposed in the neighborhood of said master receiver, said master receiver reads the data stored in the built-in memory upon the data transfer, FSK-modulates an oscillation signal of a local oscillator using the read data, and radiates the oscillation signal generated from the local oscillator at that time into the air as a leakage radio wave; and
wherein when said at least one slave receiver receives the leakage radio wave radiated into the air, said slave receiver extracts data contained in the received signal and writes the extracted data into the corresponding built-in memory,
whereby a data transfer is performed between said master receiver and said slave receiver.

4. The data transfer system according to claim 3, wherein the local oscillator is a second local oscillator which is connected to a stage subsequent to a first frequency conversion stage and used in a second frequency conversion stage that frequency-converts a first intermediate frequency signal obtained at the first frequency conversion stage to a second intermediate frequency signal.

5. The data transfer system according to claim 3, wherein the local oscillator is a third local oscillator which is connected to a stage subsequent to the first frequency conversion stage and the second frequency conversion stage and which is used in a third frequency conversion stage that frequency-converts a second intermediate frequency signal obtained at the second frequency conversion stage to a third intermediate frequency signal.
